(19) United States
(12) Patent Application Publication
(10) Pub. No.: US 2009/0223938 A1
(43) Pub. Date: Sep. 10, 2009

(54) Fusing quality control method and apparatus

(75) Inventors: Tadashi Kawagoe, Obu-city (JP); Kazuyoshi Suzuki, Higashiura-cho (JP); Hajime Fushimoto, Chiryu-city (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/379,792

(22) Filed: Mar. 2, 2009

(30) Foreign Application Priority Data
Mar. 5, 2008 (JP) 2008-054966

(51) Int. Cl. B23K 11/25; B23K 11/00

(52) U.S. Cl. 219/110; 219/117.1

(57) ABSTRACT

A fusing quality control method and apparatus are disclosed in which the film detachment process is accurately controlled by monitoring the surface temperature of a terminal and detecting the timing at which the temperature provisionally drops and then rises again. The thermal caulking process, on the other hand, is accurately controlled by accumulating the terminal temperature to determine the heat amount charged into the film covered electric wire 3 and by monitoring whether the accumulated heat amount has entered a preset range or not.

### BACKGROUND OF THE INVENTION

1. Technical Field of the Invention

This invention relates to a fusing quality control method and apparatus capable of judging fusing quality with high accuracy in a fusing process for welding a film covered electric wire held in a folded terminal.

2. Description of the Related Art

The fusing process is conventionally used for solid-state coupling in which solids are coupled to each other. The fusing process is defined as a thermal caulking in which current is supplied between a covered conductor and a terminal in pressure contact with each other to generate resistance heat and remove the film, after which the exposed conductor is kept energized to couple the conductor and the terminal to each other while being heated in pressure contact. The fusing process is regarded as a suitable method of coupling metals to each other in the case where the insulation film is formed of a heat resistant material having a carbonization temperature of 370° C. and cannot be soldered.

Japanese Unexamined Patent Publication No. 2001-138064 discloses a resistance welding quality control method, a resistance welding method and a resistance welding apparatus.

Specifically, according to Japanese Unexamined Patent Publication No. 2001-138064, a voltage between a pair of electrodes is measured, and based on this voltage, the heat amount generated by the core wire to be welded is calculated. Based on this heating value, the welding quality of the electric wires with the core wires welded to each other is judged.

According to Japanese Unexamined Patent Publication No. 2007-73476, on the other hand, with the aim of improving the yield of a molded component by controlling and stabilizing the temperature of the electrodes supplying the current to the lead wire in contact with a support member and a fixing member to fix the lead wire, a work is held and heated in pressure contact between an upper electrode and a lower electrode. A thermocouple is mounted on the lower electrode, and the temperature of the two electrodes holding the work is detected thereby to judge by measurement whether the temperature of the electrodes is proper or not.

Japanese Unexamined Patent Publication No. 2006-110613 also discloses a resistance welding apparatus and a resistance welding method for judging the quality of the welding process of a work to weld the work positively at the desired strength.

The core wire of an electric wire to be welded is held by a pair of electrodes, between which the current is supplied to weld the core wires to each other. In the process, the welding situation is grasped by calculating the energy applied per unit area of the contact surface between the core wires.

Further, according to Japanese Unexamined Patent Publication No. 2005-125350, the welding current is controlled by detecting the temperature of the terminal joint in order to prevent the folded terminal from cracking.

As described above, the fusing quality is generally controlled based on the heating value and the crushing amount of the terminal. The method in which the heating value is simply calculated; however poses the problem of the secular variation of the electrodes and the variation of the terminal crush amount due to the change in the terminal caulking amount.

In view of this, the present applicant has found a method of judging the quality with high accuracy by separating the fusing into the film detachment and the thermal caulking and controlling each process.

Specifically, the inventor has took the note of the fact that the insulating material used in the film process for the film covered electric wire is carbonized at about 300 to 400° C. and sublimated into a fume at a higher temperature, resulting in the removal of the film. More specifically, since the film covered electric wire is held in the terminal, the terminal is deprived of heat while the film is sublimated. Thus, by measuring the surface temperature of the terminal and detecting the timing at which the temperature drops and rises again, the detachment process can be accurately controlled.

In the thermal caulking process, on the other hand, the inventor has taken note of the fact that the stable joint strength can be obtained by optimizing the heat amount charged into the work. Specifically, by accumulating the terminal temperature, the heat amount charged into the work is determined, and by checking whether a preset accumulated heat amount is reached or not, the thermal caulking process can be accurately controlled.

Incidentally, the heat amount may alternatively be determined simply by measuring the current and the voltage between the electrodes and calculating the sum-of-the products of the current and the voltage.

By judging whether the two processes described above are carried out properly within a predetermined energization time, it has been found that the fusing quality can be judged with high accuracy without being affected by the variation factors such as the secular variation of the electrodes or the change in the terminal caulking amount.

### SUMMARY OF THE INVENTION

This invention is proposed from the viewpoint described above and an object of this invention is to provide a fusing quality control method and apparatus in which the fusing is separated into the film detachment process and the thermal caulking process, and each process is appropriately controlled so that the fusing quality can be judged with high accuracy free of the effects of the variation factors such as the secular variation of the electrodes and the change in the terminal caulking amount.

In order to solve the problems described above, according to a first aspect of the invention, there is provided a fusing quality control method, in which a work W including a folded terminal 2 and a film covered electric wire 3 held in the folded terminal 2 is welded by supplying the current to the covered wire through the folded terminal 2, comprising:

the film detachment process for monitoring the surface temperature of the folded terminal 2 to judge whether the covering is separated or not; and

the thermal caulking process for monitoring the heat amount accumulated in the work W after separation of the film from the film covered electric wire 3 through the folded terminal and judging the quality of the welded part.

In this way, the two processes described above can be accurately controlled. The thermal caulking process, for example, can be accurately controlled by monitoring the accumulated heat amount in the work W and detecting whether the accumulated value of the heat amount has reached a preset value.

According to a second aspect of the invention, there is provided a fusing quality control method:

wherein the film detachment process includes the steps of monitoring the surface temperature of the folded terminal 2, detecting the timing at which the temperature drops and then rises, and judging that the film of the film covered electric wire 3 is sublimated and completely separated.

In this way, the film detachment process can be accurately controlled.

According to a third aspect of the invention, there is provided a fusing quality control method:

wherein the thermal caulking process includes the steps of measuring the amount of heat generated in the work W and accumulating the heat amount charged, monitoring whether the accumulated amount is within a range of a preset value or not, outputting a signal indicating a high quality of the coupling in the case where the accumulated heat amount is within the range of the preset value, and outputting a signal indicating a coupling failure in the case where the accumulated amount is not included in the range of the set value.

In this way, the thermal caulking process can be monitored with high accuracy, and the quality of the welded part can be judged without being affected by the variation factors such as the secular variation of the electrodes and the change in the terminal caulking amount.

According to a fourth aspect of the invention, there is provided a fusing apparatus for fusing and welding a film covered electric wire 3 held in a folded terminal 2, comprising:

a pair of electrodes 4 holding a work W including the folded terminal 2 and the film covered electric wire 3 held in the folded terminal 2;

a welding power supply 5 for supplying power to the electrodes 4;

a temperature measuring unit 6 for detecting the surface temperature of the folded terminal 2;

a current sensor 7 for detecting the current supplied to the electrodes 4; and

a control unit 8 for monitoring the surface temperature of the folded terminal 2 by the temperature measuring unit 6, judging whether the film is separated or not by detecting the timing at which the temperature temporarily drops and then rises again, accumulating the surface temperature of the folded terminal 2 thereby to determine the heat amount charged, and outputting a signal judging the quality of the welded part by monitoring whether the heat amount is within a preset range of the accumulated heat amount.

In this way, the surface temperature of the folded terminal 2 is monitored by the temperature measuring unit 6, and a temperature drop, once detected by the temperature measuring unit 6, shows that the surface film m is softened, pushed out and separated from the terminal 2.

Further, in the case where the rise of the surface temperature of the folded terminal 2 is detected by the temperature measuring unit 6, it shows that the film m of the film covered electric wire 3 is sublimated and separated. Thus, the operation is transferred from the film detachment process to the thermal caulking process in accordance with a set program.

In the thermal caulking process, the control unit 8 accumulates the terminal temperature to determine the heat amount charged into the film covered electric wire 3, and by monitoring whether the accumulated heat amount is within a preset range or not, can accurately control the thermal caulking process.

Incidentally, the reference numerals inserted in the parentheses indicating each of the means described above are only an example indicating the correspondence with the specific means described later in the embodiments.

The present invention may be more fully understood from the description of preferred embodiments of the invention, as set forth below, together with the accompanying drawings.

### BRIEF DESCRIPTION OF THE DRAWINGS

FIG. 1 is a schematic diagram for explaining the configuration of an example of the fusing apparatus according to this invention.

FIG. 2 is a schematic diagram showing the fusing process in which the film covered electric wire is held in the terminal under pressure.

FIG. 3 is a schematic diagram showing the fusing process in which the current is supplied while the film covered electric wire is held in the terminal under pressure.

FIG. 4 is a schematic diagram showing the fusing process in which the film detachment is promoted by the heat generated in the terminal to which the current is supplied.

FIG. 5 is a schematic diagram showing the fusing process in which the terminal and the electric wire are brought into direct contact with each other by the film detachment and the current is supplied to the electric wire as well as the terminal.

FIG. 6 is a schematic diagram showing the fusing process upon completion of the welding process.

FIG. 7 is a flowchart showing the quality judgment steps of the film detachment process and the thermal caulking process in the fusing process according to this invention.

FIG. 8 is a graph showing the relation between the welding current conduction time and the accumulated heat amount for each conduction current in the fusing apparatus according to this invention.

### DESCRIPTION OF THE PREFERRED EMBODIMENTS

### First Embodiment

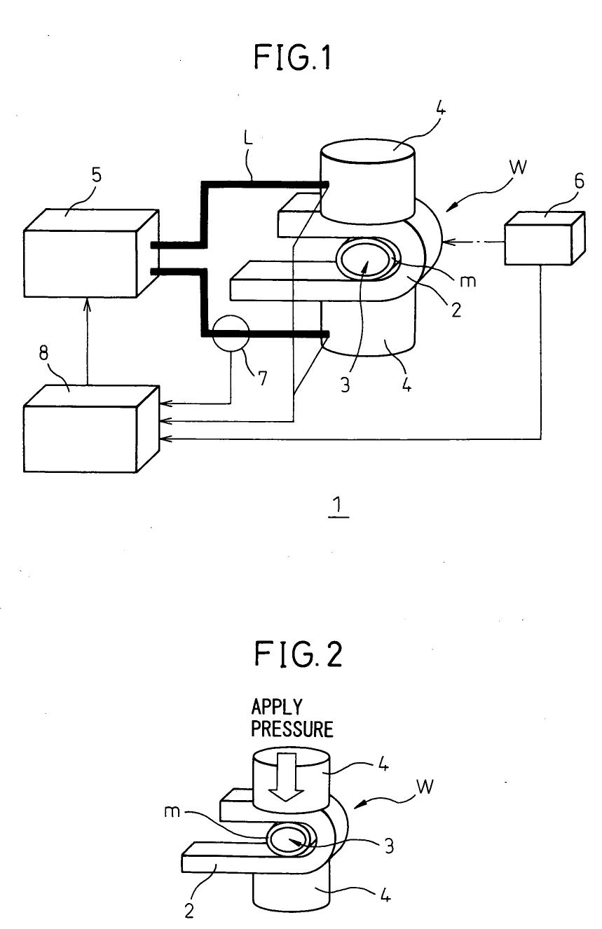

FIG. 1 shows a fusing apparatus 1.

The fusing apparatus 1 is for executing the fusing process by welding a work W including a folded terminal 2 and a film covered electric wire 3 held in the folded terminal 2.

Specifically, the fusing apparatus 1 is configured of a pair of electrodes 4 for holding a work W including the folded terminal 2 and the film covered electric wire 4 held in the folded terminal 2, wherein power is supplied to the electrode pair 4 under the pressure maintained by a predetermined pressuring means.

The fusing apparatus 1 also includes a welding power supply 5 for supplying power to the electrodes 4 through power lead wires L, a temperature measuring unit 6 for detecting the temperature of the folded terminal 2, and a current sensor 7 arranged on the power lead wires L to detect the current flowing through the electrodes 4.

Further, the fusing apparatus 1 includes a control unit 8 for outputting a current conduction command and other control commands to the welding power supply 5 based on the energization of the electrode pair 4, the temperature of the folded terminal 2 detected by the temperature measuring unit 6 and the current detected by the current sensor 7.

The folded terminal 2 is a thin plate of a conductive metal, such as Cu, pressed through the electrode pair 4 by an appropriate pressuring means (not shown) with the film covered electric wire 3 held therein. The electrodes 4 are cylindrical members of tungsten or the like and receive the welding current from a welding power supply 5 described later through the power lead wires L.

The film covered electric wire 3 is covered with a well-known heat-resistant insulation film m on the surface thereof.

The welding power supply 5 is of, for example, AC type or inverter type adapted to control the output waveform. Specifically, in accordance with the energization command or other control commands from the control unit 8 described later, the energization time and the output waveform of the welding power supply 5 can be control to produce the desired welding current. In this way, the power of the welding power supply 5 can be continuously controlled without any dwell thereby to increase the temperature of the welded part continuously for a higher thermal efficiency.

An infrared rays temperature sensor of no-contact type, for example, may be used as the temperature measuring unit 6, which is arranged in such a manner as to detect the temperature of the bend of the folded terminal 2 holding the film covered electric wire 3. The temperature measuring unit 6 outputs a voltage signal corresponding to the detection temperature to the control unit 8.

A clamp-type AC current sensor (current transformer) can be used as the current sensor 7. As an alternative, a Hall current sensor using a Hall element may be used. A voltage signal corresponding to the welding current supplied to the electrodes 4 is output from the current sensor 7 to the control unit 8.

The control unit 8, having a well-known hardware configuration (I/O interface, CPU, memory, etc.), retrieves the detection signals from the temperature measuring unit 6 and the current sensor 7, and after the signal processing and the predetermined data processing, executes the arithmetic operation and the judgment process based on a preset program.

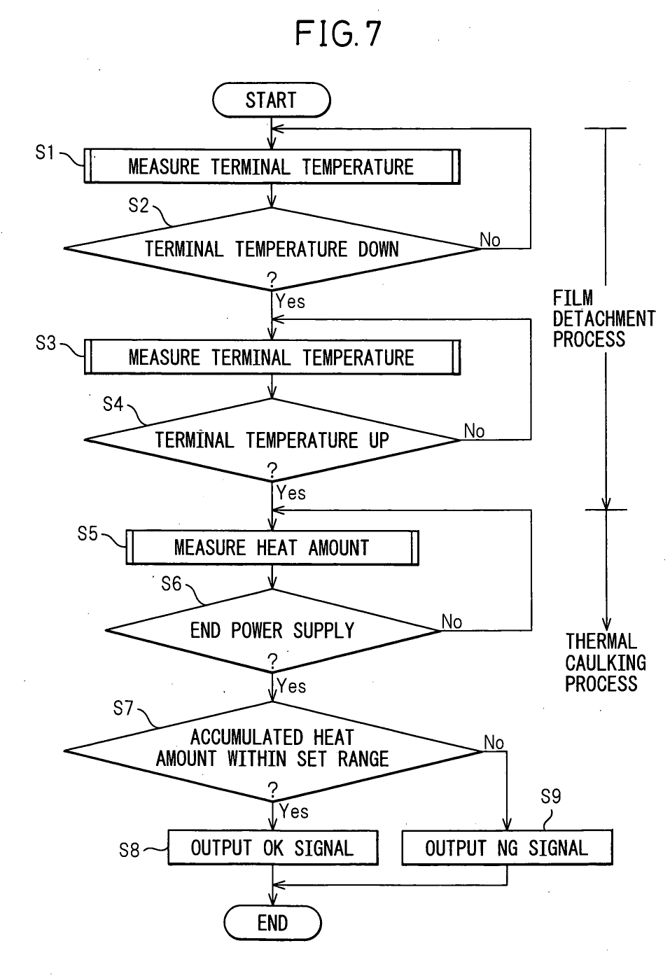

Next, the steps of the fusing process executed by the fusing apparatus 1 described above are explained with reference to the flowchart of FIG. 7.

First, the film covered electric wire 3 to be fused is held at the bend of the folded terminal 2 between the pair of the electrodes 4 and pressured by a predetermined pressuring means through the electrodes 4 (FIG. 2).

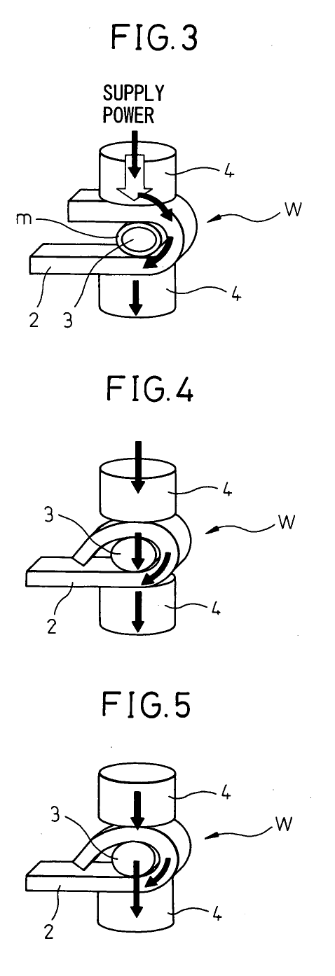

The fusing apparatus 1 is activated, and the current supplied from the welding power supply 5 through the power lead wires L and the electrode pair 4 (FIG. 3).

In the initial stage of the process, the current flows through the terminal 2. As a result, the forward ends of the two electrodes 4 and the terminal 2 are heated, followed by heating the film covered electric wire 3 held in the terminal 2.

According as the film covered electric wire 3 is heated, the surface film m is softened, pushed out and separated from the terminal 2. Thus, the contact surfaces of the terminal 2 and the film covered electric wire 3 are brought into direct contact and electrically connected with each other (FIG. 4).

The process described above proceeds as a film detachment process according to the program set initially (FIG. 7). Specifically, the temperature measuring unit 6 in the fusing apparatus 1 monitors the surface temperature of the folded terminal 2 (FIG. 1, step S1). A temperature drop, if detected, by the temperature measuring unit 6 (step S2) shows, as described above, that the surface film m is softened, pushed out and separated from the terminal 2. Specifically, the film m deprives the terminal 2 of heat while being separated, and therefore, the temperature temporarily drops. Incidentally, the temperature drop is probably caused not only by the film m depriving the terminal 2 of heat but also by the decreased current density due to the electric connection established between the terminal 2 and the film covered electric wire 3.

The temperature measuring unit 6 further continues to monitor the surface temperature of the folded terminal 2 (step S3), and once the rise of the surface temperature is detected (step S4), it indicates that the film m of the film covered electric wire 3 is sublimated and separated. Thus, the operation proceeds from the film detachment process to the thermal caulking process in accordance with a set program.

In this case, the terminal 2 and the film covered electric wire 3 are electrically connected and the tolerable current increased. Therefore, a control command can be sent out to the welding power supply 5 from the control unit 8 to increase the current amount.

As a result, the thermal caulking process, i.e. the welding process between the terminal 2 and the film covered electric wire 3 is promoted (FIG. 5).

The control unit 8 measures the heat amount (step S5). The heat amount can also be measured by measuring, for example, the current and the voltage between the electrodes. Specifically, the data on the heat amount can be extracted from the data table stored in a memory, for example, based on the current detected by the current sensor 7 and supplied to the electrodes 4 and the voltage between the pair of the electrodes 4, or as Joule heat by a predetermined arithmetic operation from the current supplied to the electrodes 4 and the voltage between the pair of the electrodes 4.

Then, the control unit 8 judges whether the current is completely supplied to the electrodes 4 or not (step S6), and if completed, accumulates the heat amount thus far measured to judge whether the accumulated heat amount is within a preset range (whether the heat amount required to complete the coupling is reached or not) (step S7).

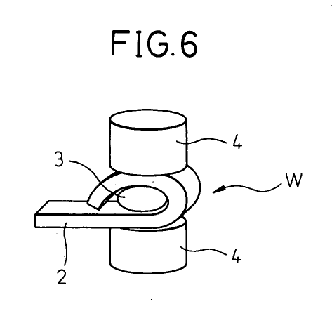

Upon judgment that the accumulated heat amount is within the preset range, the control unit 8 decides that it indicates that the coupling having the required joint strength is completed (FIG. 6), and outputs an OK signal indicating that a satisfactory coupling is achieved (step S8). In the case where the accumulated heat amount received by the caulked portion is not included in the set value range, on the other hand, a NG signal indicating a coupling failure is output (step S9), thereby finishing the series of the process.

In the fusing apparatus 1 described above, the fusing is divided into the film detachment process and the thermal caulking process, and each process is appropriately monitored. In this way, the fusing with a stable joint strength can be realized.

Specifically, the film detachment process is can be accurately controlled by monitoring the surface temperature of the terminal and detecting the timing at which the temperature drops and then rises again.

The thermal caulking process, on the other hand, can be accurately controlled by accumulating the terminal temperature to determine the heat amount charged into the film covered electric wire 3, and by monitoring whether the accumulated heat amount has reached a preset range.

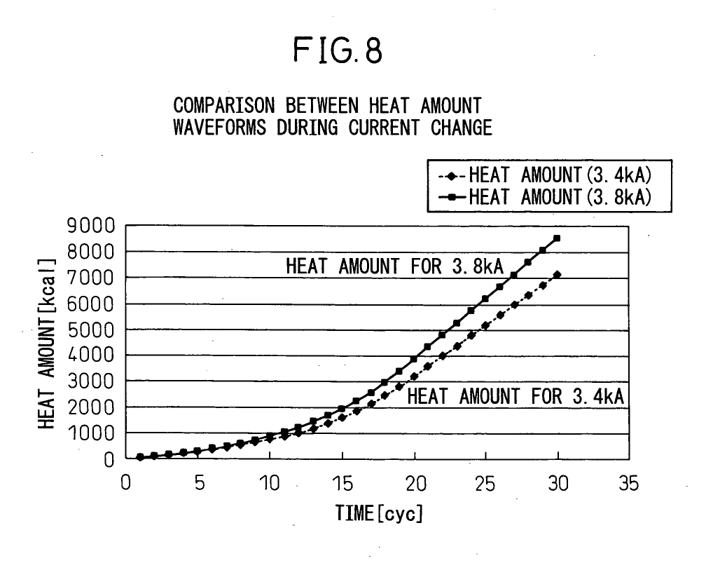

In the fusing apparatus 1 described above, the accumulated heat amount with a change in the current supplied to the electrodes is shown for reference in FIG. 8. In this graph, the abscissa represents the current conduction time (cyc) and the ordinate the heat amount (kcal).

From FIG. 8, it is easily understood that the supplied current and the accumulated heat amount are linearly proportional to each other during a predetermined time (16 to 30 cyc), and for the same conduction time length, the larger the supplied current (3.8 kA), the larger the accumulated heat amount.

This also shows that the welding process can be accurately controlled by facilitating the setting of the heat amount required for the welding process and determining the supplied current and the conduction time in advance in accordance with the work to be welded.

While the invention has been described by reference to specific embodiments chosen for purposes of illustration, it should be apparent to those skilled in the art that numerous modifications could be made thereto without departing from the basic concept and scope of the invention.

1. A fusing quality control method for welding a work including a folded terminal and a film covered electric wire held in the folded terminal, by supplying the current to the film covered electric wire through the folded terminal, comprising:
the film detachment process for monitoring the surface temperature of the folded terminal and judging whether the film of the electric wire is separated or not; and
the thermal caulking process for monitoring, through the folded terminal, the accumulated heat amount in the work after separation of the film from the film covered electric wire and judging the quality of the welded part.

2. The fusing quality control method according to claim 1,
wherein the film detachment process includes the steps of:
monitoring the surface temperature of the folded terminal and detecting the timing at which the temperature drops temporarily and then rises again; and
deciding that the film of the film covered electric wire is sublimated and separated and finishing the film detachment process.

3. The fusing quality control method according to claim 1,
wherein the thermal caulking process includes the steps of:
measuring the amount of heat generated in the work and accumulating the heat amount charged;
monitoring whether the accumulated heat amount is within a preset range or not;
outputting a signal indicating a high quality of the coupling in the case where the accumulated heat amount is within the preset range; and
outputting a signal indicating a coupling failure in the case where the accumulated heat amount is out of the preset range.

4. A fusing apparatus for welding a work including a folded terminal and a film covered electric wire held in the folded terminal, comprising:
a pair of electrodes holding the work with the film covered electric wire held in the folded terminal;
a welding power supply for supplying power to the electrodes;
a temperature measuring unit for detecting the surface temperature of the folded terminal;
a current sensor for detecting the current supplied to the electrodes; and
a control unit for monitoring the surface temperature of the folded terminal by the temperature measuring unit and detecting the timing at which the temperature drops and then rises thereby to judge whether the film is separated or not, accumulating the surface temperature of the folded terminal thereby to determine the heat amount charged, and outputting a signal for judging the quality of the welded part by monitoring whether the accumulated heat amount is within a preset range of the heat amount.
